(19) United States
(12) Patent Application Publication
(10) Pub. No.: US 2026/0152094 A1
(43) Pub. Date: Jun. 4, 2026

(54) BATTERY CONDITIONING OPTIMIZATION METHOD AND APPARATUS FOR VEHICLE

(71) Applicant: Hyundai Kefico Corporation, Gunpo (KR)

(72) Inventors: Byung Gun Kim, Gunpo (KR); Young Ho Jun, Gunpo (KR)

(21) Appl. No.: 19/405,227

(22) Filed: Dec. 1, 2025

(30) Foreign Application Priority Data
Dec. 2, 2024 (KR) 10-2024-0176479

(51) Int. Cl. B60L 58/26; B60L 58/27

(52) U.S. Cl. CPC B60L 58/26; B60L 58/27; B60L 2240/545; B60L 2240/64; B60L 2240/662; B60L 2250/00

(57) ABSTRACT

A battery conditioning optimization method for a vehicle includes a controller and a memory, where the controller is configured to: collect in real time driving data that affects driving conditions of the vehicle, analyze the collected driving data, and determine the driving conditions, monitor a current temperature and a state of a battery, forecast battery temperature changes based on the current temperature and the state of the battery and information on the driving conditions, and determine whether to control the temperature of the battery based on the predicted battery temperature changes, and cooling the battery or raising the temperature of the battery.

### CROSS-REFERENCE TO RELATED APPLICATION

The present application claims under 35 U.S.C. § 119(a) the benefit of Korean Patent Application No. 10-2024-0176479, filed on Dec. 2, 2024 in the Korean Intellectual Property Office, the entire contents of which are incorporated herein by reference.

### BACKGROUND

### 1. Technical Field

The present disclosure relates to a battery conditioning optimization method and apparatus for a vehicle, more particularly, to the method and apparatus configured to optimize battery performance based on vehicle driving conditions.

2. Description of the Related Art

In electric vehicles, accurately measuring a remaining amount of charge in a battery is important. The related art provides a function of forecasting a remaining charging time based on an algorithm for forecasting a battery charging time when an electric vehicle arrives at a charging station. However, such an approach does not sufficiently consider battery temperature as an important factor in optimizing battery charging efficiency.

Battery performance is significantly affected by changes in ambient temperature. In some cases, battery performance is degraded due to changes in ambient temperature, causing problems with vehicle operation. Time required for battery charging is also significantly affected by temperature.

Battery temperature during driving varies depending on various variables such as driving habits of a driver, road conditions, and environmental factors, and forecasting not considering such variables may reduce charging efficiency and extend charging time.

### SUMMARY

Various embodiments are directed to providing a battery conditioning optimization method and apparatus that can shorten battery charging time.

Various embodiments are directed to providing a battery conditioning optimization method and apparatus that can start charging under optimal conditions when an electric vehicle arrives at a charging station.

Various embodiments are directed to providing a battery conditioning optimization method and apparatus that can protect battery performance and lifespan by maximizing battery charging efficiency.

According to the present disclosure, a battery conditioning optimization apparatus for a vehicle includes: a controller and a memory, the controller comprising: a driving condition determination unit configured to: collect in real time driving data that affects driving conditions of the vehicle, analyze the collected driving data, and determine the driving conditions; a battery temperature change forecasting unit configured to: monitor a current temperature and a state of a battery, and forecast battery temperature changes based on the current temperature and the state of the battery and information on the driving conditions provided by the driving condition determination unit; and a battery conditioning unit including a cooling device for lowering a temperature of the battery and a heating device for raising the temperature of the battery, and configured to cool the battery or raise the temperature of the battery under the control of the battery temperature change forecasting unit, wherein the battery temperature change forecasting unit controls the battery conditioning unit to control the temperature of the battery based on the forecasted battery temperature changes.

According to one aspect, a battery conditioning optimization apparatus includes: a driving condition determination unit configured to collect in real time driving data that affects vehicle driving conditions, to analyze the collected driving data, and to determine the driving conditions; a battery temperature change forecasting unit configured to monitor current temperature and state of a battery, and to forecast battery temperature changes based on the current temperature and state of the battery and information on the driving conditions provided by the driving condition determination unit; and a battery conditioning unit including a cooling device for lowering temperature of the battery and a heating device for raising the temperature of the battery, and configured to cool the battery or raise the temperature of the battery under the control of the battery temperature change forecasting unit. The battery temperature change forecasting unit controls the battery conditioning unit to control the temperature of the battery based on the forecasted battery temperature changes.

In an embodiment, the battery temperature change forecasting unit includes a plurality of battery temperature forecasting models. The driving condition determination unit determines current driving conditions and selects a battery temperature forecasting model suitable for the current driving conditions from the plurality of battery temperature forecasting models.

In an embodiment, the battery temperature change forecasting unit forecasts the battery temperature changes to calculate time required to reach optimal temperature. The battery temperature change forecasting unit compares the calculated time required to reach the optimal temperature with remaining driving time until arrival at a charging station, and determines whether to activate battery conditioning control.

In an embodiment, the battery temperature change forecasting unit includes map data that records a relationship among cooling or heating time required to reach an optimal battery state, current battery temperature, and ambient temperature. The battery temperature change forecasting unit calculates the cooling or heating time required to reach the optimal battery state by using the map data.

In an embodiment, when a difference between the remaining driving time and the cooling or heating time required to reach the optimal state is within a predetermined error range, the battery temperature change forecasting unit controls the battery conditioning unit to perform a battery conditioning operation.

In an embodiment, the battery temperature change forecasting unit adjusts a data collection and processing cycle according to a driving section during driving or an event that occurs.

In an embodiment, the battery temperature change forecasting unit forecasts battery temperature over time by repeating a process of forecasting of temperature after a predetermined time by using data during immediately previous predetermined timestamps at a current time point, and forecasting of temperature after a predetermined time by using data during immediately previous predetermined timestamps with respect to a time point after the predetermined time.

In an embodiment, a driving condition determination algorithm of the driving condition determination unit may be implemented using an artificial intelligence model trained using various driving data.

In an embodiment, the battery conditioning optimization apparatus performs a battery conditioning operation when a charging station is set in a navigation system as a destination.

In an embodiment, the driving data that affects the vehicle driving conditions may include driver's driving characteristics, road conditions, and environmental factors. According to the present disclosure, a battery conditioning optimization method for a vehicle includes steps of: collecting, by a controller, in real time driving data that affects driving conditions of the vehicle, analyzing the collected driving data, and determining the driving conditions; monitoring, by the controller, a current temperature and a state of a battery, forecasting battery temperature changes based on the current temperature and the state of the battery and information on the driving conditions, and determining whether to control the temperature of the battery based on the predicted battery temperature changes; and cooling the battery or raising the temperature of the battery, by the controller, according to the determination.

According to another aspect, a battery conditioning optimization method includes: a driving condition determination step of collecting in real time driving data that affects vehicle driving conditions, analyzing the collected driving data, and determining the driving conditions; a battery temperature change forecasting step of monitoring current temperature and state of a battery, forecasting battery temperature changes based on the current temperature and state of the battery and information on the driving conditions provided in the driving condition determination step, and determining whether to control the temperature of the battery based on the predicted battery temperature changes; and a battery conditioning step of cooling the battery or raising the temperature of the battery according to a determination in the battery temperature change forecasting step.

In an embodiment, the battery temperature change forecasting step may be performed by one of a plurality of battery temperature forecasting models. The driving condition determination step includes a step of determining current driving conditions and selecting, as the one battery temperature forecasting model to be performed, a battery temperature forecasting model most suitable for the current driving conditions from the plurality of battery temperature forecasting models.

In an embodiment, the battery temperature change forecasting step includes a step of forecasting the battery temperature changes to calculate time required to reach optimal temperature, and a step of comparing the calculated time required to reach the optimal temperature with remaining driving time until arrival at a charging station, and determining whether to activate battery conditioning control.

In accordance with the battery conditioning optimization method according to an embodiment of the present disclosure, in the battery temperature change forecasting step, cooling or heating time required to reach an optimal battery state may be calculated using map data that records a relationship among the cooling or heating time, current battery temperature, and ambient temperature.

In an embodiment, the battery conditioning step includes a step of performing a battery conditioning operation when a difference between the remaining driving time and the cooling or heating time required to reach the optimal state is within a predetermined error range.

In an embodiment, the battery temperature change forecasting step may further include a step of adjusting a data collection and processing cycle according to a driving section during driving or an event that occurs.

In an embodiment, the battery temperature change forecasting step includes a step of forecasting battery temperature over time by repeating a process of forecasting of temperature after a predetermined time by using data during immediately previous predetermined timestamps at a current time point, and forecasting of temperature after a predetermined time by using data during immediately previous predetermined timestamps with respect to a time point after the predetermined time.

In an embodiment, the driving condition determination step may be implemented using an artificial intelligence model trained using various driving data.

The battery conditioning optimization method according to an embodiment of the present disclosure performs a battery conditioning operation when a charging station is set in a navigation system as a destination.

In an embodiment, the driving data that affects the vehicle driving conditions include driver's driving characteristics, road conditions, and environmental factors.

According to the present disclosure, a non-transitory computer readable medium containing program instructions executed by a processor includes: program instructions that collect in real time driving data that affects driving conditions of a vehicle, analyze the collected driving data, and determine the driving conditions; program instructions that monitor a current temperature and a state of a battery, forecast battery temperature changes based on the current temperature and the state of the battery and information on the driving conditions, and determine whether to control the temperature of the battery based on the predicted battery temperature changes; and program instructions that cool the battery or raise the temperature of the battery, according to the determination.

According to an embodiment of the present disclosure, charging is allowed to be started under optimal conditions when an electric vehicle user arrives at a charging station, so that it is possible to shorten charging time and protect battery performance and lifespan.

According to an embodiment of the present disclosure, by using a battery temperature forecasting model suitable for current driving situations, the accuracy of battery temperature forecasting is increased.

According to an embodiment of the present disclosure, battery charging efficiency can be maximized by determining an appropriate battery conditioning intervention time point based on an artificial intelligence-based battery temperature forecasting and control algorithm that considers driving efficiency and charging efficiency.

### BRIEF DESCRIPTION OF THE DRAWINGS

FIG. 1 is a functional block diagram illustrating a configuration of a battery conditioning optimization apparatus according to an embodiment of the present disclosure.

FIG. 2 is a flowchart showing an operational flow of a battery conditioning optimization method according to an embodiment of the present disclosure.

FIG. 3A exemplifies the time required to reach optimum temperature when a battery conditioning function is performed, and FIG. 3B illustrates predicted changes in battery temperature over time when the battery conditioning function is not performed.

FIG. 4 is a diagram for explaining a method for forecasting temperature after one second by using data during immediately previous 60 timestamps according to an embodiment of the present disclosure.

FIG. 5 is a diagram for explaining a method for forecasting temperature by moving a time window.

FIG. 6 is a graph showing the relationship between charging time and battery temperature.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The advantages and characteristics of the present disclosure and a method for achieving them will become apparent from the embodiments described in detail below in conjunction with the accompanying drawings. However, the present disclosure is not limited to the disclosed embodiments, but will be implemented in various different forms. The embodiments below are nothing but the ones provided to bring the disclosure of the present disclosure to perfection and assist those skilled in the art to which the present disclosure pertains to completely understand the scope of the present disclosure. The present disclosure is defined only by the scope of the appended claims.

Terms used in this specification are used to describe embodiments and are not intended to limit the present disclosure. In this specification, an expression of the singular number includes an expression of the plural number unless clearly defined otherwise in the context.

Terms such as first and second may be used to describe various components, but the components should not be limited by the above terms. The above terms may be used to distinguish one component from another component. For example, a first component may be referred to as a second component and similarly, the second component may also be referred to as a first component without departing from the scope of the present disclosure.

When it is described that one component is “connected” or “coupled” to another component, it should be understood that one component may be directly connected or coupled to the another component, but another component may exist between the two components. On the other hand, when it is described that one component is “directly connected to” or “directly coupled to” another component, it should be understood that another component does not exist between the two components.

Other expressions for explaining the relationship between components, such as “between” and “directly between” or “adjacent to” and “directly adjacent to”, should also be interpreted similarly.

In the description of the present disclosure, when it is determined that detailed descriptions of related publicly-known technologies may unnecessarily obscure the subject matter of the present disclosure, the detailed descriptions thereof will be omitted.

Hereinafter, embodiments of the present disclosure are described in detail with reference to the accompanying drawings. In order to facilitate the overall understanding in describing the present disclosure, the same reference numerals are used for the same components, regardless of the drawing number.

The present disclosure proposes a battery temperature forecasting system that overcomes the limitations of the related art and can shorten battery charging time. The present disclosure enables efficient battery temperature management by accurately forecasting battery temperature upon arrival at a charging station through an artificial intelligence model.

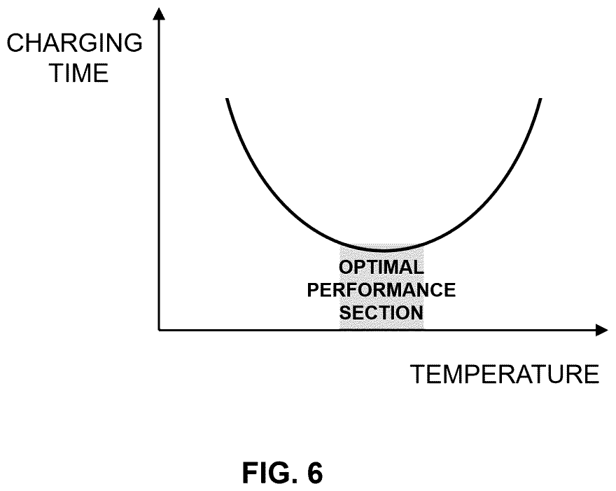

Charging time and battery temperature may have a relationship as illustrated in FIG. 6, and the present disclosure controls battery temperature to reach an optical performance section that can minimize charging time immediately before charging. The present disclosure focuses on the fact that battery temperature changes significantly vary depending on vehicle's driving conditions. An individual driver's driving habits such as rapid acceleration and rapid braking, road gradient and surface conditions, air temperature, and weather all have a significant influence on battery temperature.

The present disclosure reflects such variables in real time and controls battery temperature to reach optimal temperature immediately before charging. That is, in order to improve battery charging efficiency (increase in charge capacity and reduction in charging time), the present disclosure performs thermal management control so that the battery temperature can be maintained at, for example, 30° C. or less upon arrival at a charging station.

To this end, cooling or heating time required to reach an optimal battery state can be configured as map data based on current battery temperature and ambient temperature, and can be compared with the remaining driving time available up to a charging station, thereby starting battery conditioning control when the remaining driving time reaches the time required to reach the optimal battery state.

This maximizes charging efficiency and allows electric vehicle users to start charging under optimal conditions upon arrival at the charging station, thereby shortening charging time and protecting battery performance and lifespan.

Embodiments of the present disclosure are described below in detail with reference to the drawings.

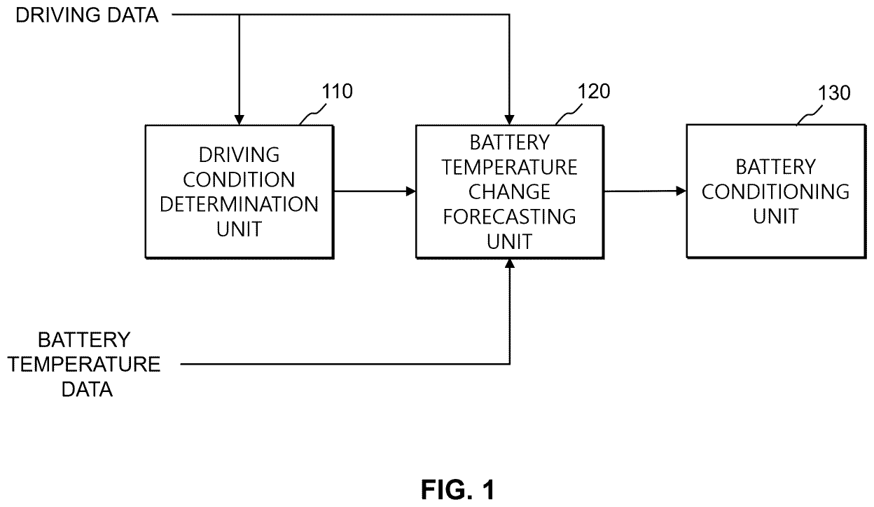

FIG. 1 is a functional block diagram illustrating a configuration of a battery conditioning optimization apparatus according to an embodiment of the present disclosure.

The present disclosure can initiate an operation when a driver inputs a charging station to the navigation system as a destination and starts driving. Depending on embodiments, battery conditioning can also be manually activated when desired by a user. Depending on embodiments, battery conditioning can also be manually activated even when a user inputs a destination other than a charging station to the navigation system.

Referring to FIG. 1, a battery conditioning optimization apparatus according to the present disclosure may be provided in a vehicle, and further may include a plurality of units. Each of the units may constitute modules and/or devices of the battery conditioning optimization apparatus, which may be a controller. For example, the units of the battery conditioning optimization apparatus may constitute hardware components that form part of a controller (e.g., modules or devices of a high-level controller), or may constitute individual controllers each having a processor and memory. The battery conditioning optimization apparatus may include one or more processors and memory.

A driving condition determination unit 110 determines current driving conditions and selects a battery temperature forecasting model suitable for the current driving conditions from a plurality of battery temperature forecasting models. The driving conditions can be ascertained from a route to a destination. Examples of the driving conditions may include urban driving, high-speed driving, driving under extreme cold weather conditions, and driving under extreme hot weather conditions. When the driving condition is urban driving, the driving condition determination unit 110 selects a battery temperature forecasting model suitable for urban driving. Depending on embodiments, a process of selecting one of the plurality of battery temperature forecasting models may also be omitted by allowing one battery temperature forecasting model to be used.

The driving condition determination unit 110 receives data such as a distance to a charging station, predicted time required to the charging station, and a predicted average speed until arrival at the charging station, and ascertains the driving conditions based on the received data. In an embodiment, the driving condition determination unit 110 collects in real time driving data that affects vehicle driving conditions such as driver's driving characteristics, road conditions, and environmental factors, by using stored data and internal and external vehicle sensors, and ascertains the driving conditions. In an embodiment, the driver's driving characteristics may be ascertained from data accumulated over time during driving. In an embodiment, the road conditions may be ascertained from data on a route to the destination or from vehicle sensors during driving. The environmental factors may include weather conditions such as fog, snow, and rain, ambient temperature, and the like, and may be ascertained from data measured by cameras and sensors such as temperature sensors.

Information on the ascertained driving conditions may be provided to a battery temperature change forecasting unit 120 at the request of the battery temperature change forecasting unit 120. In an embodiment, a driving condition determination algorithm of the driving condition determination unit 110 may be implemented using an artificial intelligence model trained using various driving data.

When the driving condition determination unit 110 selects the battery temperature forecasting model suitable for the current driving conditions, the battery temperature change forecasting unit 120 forecasts battery temperature changes by using the selected battery temperature forecasting model and calculates the time required to reach optimal temperature. The battery temperature change forecasting unit 120 may monitor current temperature and state of a battery in real time, and forecast battery temperature changes based on the current temperature and state of the battery and the real-time data provided by the driving condition determination unit 110.

The battery temperature change forecasting unit 120 compares the calculated time required to reach the optimal temperature with remaining driving time until arrival at the charging station, and determines whether to activate battery conditioning control. For example, the battery temperature change forecasting unit 120 may include map data that records the relationship among cooling or heating time required to reach an optimal battery state, current battery temperature, and ambient temperature. The battery temperature change forecasting unit 120 may calculate the cooling or heating time required to reach the optimal battery state by using the map data. When the remaining driving time is equal to the cooling or heating time required to reach the optimal state or falls within a predetermined error range, the battery temperature change forecasting unit 120 controls a battery conditioning unit 130 to perform a battery conditioning operation.

The battery conditioning unit 130 includes a cooling device for lowering the battery temperature and a heating device for raising the battery temperature, and cools the battery or raises the temperature of the battery under the control of the battery temperature change forecasting unit 120.

In an embodiment, the battery temperature change forecasting unit 120 may forecast the battery temperature changes in real time according to specific time points during driving such as rapid acceleration sections, rapid deceleration sections, stopping sections, or steep slope sections, and events such as reaching a specific section of a driving distance, and changes in external temperature, and determine the intervention time point of a control algorithm. In addition, the battery temperature change forecasting unit 120 may adjust a data collection and processing cycle according to a specific driving section or time point during driving or an event that occurs. For example, when rapid changes in the battery temperature are expected during driving, the battery temperature change forecasting unit 120 may perform more frequent and accurate forecasting by shortening the data collection and processing cycle. On the other hand, in constant-speed driving sections with little changes in speed during driving, the battery temperature change forecasting unit 120 may be configured to extend the data collection and processing cycle and reduce power consumption.

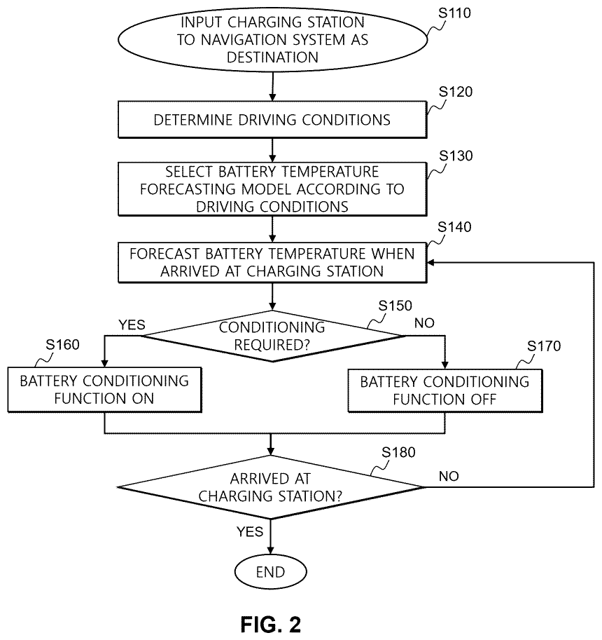

A battery conditioning optimization method according to an embodiment of the present disclosure is described below with reference to FIG. 2.

When a driver inputs a charging station to a navigation system as a destination and starts driving (step S110), operations according to the battery conditioning optimization method of the present disclosure are initiated.

The driving condition determination unit 110 determines current driving conditions from given driving data (step S120). In an embodiment, the driving condition determination unit 110 may determine driving conditions from a driving route to a charging station as a destination, current ambient temperature, and the like. For example, the driving condition determination unit 110 ascertains whether the driving is urban driving, high-speed driving, driving under extreme cold weather conditions, driving under extreme hot weather conditions, or the like.

The driving condition determination unit 110 selects a battery temperature forecasting model suitable for the current driving conditions from the plurality of battery temperature forecasting models (step S130). For example, when the driving condition is urban driving, the driving condition determination unit 110 selects a battery temperature forecasting model suitable for urban driving. Depending on embodiments, steps S120 and S130 may be omitted by using one battery temperature forecasting model.

When the driving condition determination unit 110 selects the battery temperature forecasting model suitable for the current driving conditions, the battery temperature change forecasting unit 120 forecasts battery temperature changes by using the selected battery temperature forecasting model and calculates the time required to reach optimal temperature (step S140).

The battery temperature change forecasting unit 120 may monitor the current temperature and state of a battery in real time and forecast battery temperature changes based on the current temperature of the battery. In order to forecast the battery temperature, the battery temperature change forecasting unit 120 may use real-time driving condition data provided by the driving condition determination unit 110.

The driving condition determination unit 110 receives driving data such as current ambient temperature, a distance to the charging station, predicted time required to the charging station, and a predicted average speed until arrival at the charging station, and ascertains the driving conditions based on the received data. In an embodiment, the driving condition determination unit 110 collects driving condition data in real time such as driver's driving characteristics, road conditions, and environmental factors, and ascertains the driving conditions. The data related to the ascertained driving conditions may be provided to the battery temperature change forecasting unit 120 at the request of the battery temperature change forecasting unit 120 or at a predetermined cycle. In an embodiment, the cycle at which the driving condition determination unit 110 ascertains the driving conditions and provides the driving condition data to the battery temperature change forecasting unit 120 may be changed according to a specific time point during driving and an event that occurs. In an embodiment, the driving condition determination algorithm of the driving condition determination unit 110 may be implemented using an artificial intelligence model trained using various driving data.

The battery temperature change forecasting unit 120 compares the time required to reach the optimal temperature calculated in step S140 with remaining driving time until arrival at the charging station, and determines whether to activate battery conditioning control (step S150). For example, when the remaining driving time is 30 minutes and the time required to reach the optimal battery temperature through battery heating or cooling is 30 minutes, the battery temperature change forecasting unit 120 starts the battery conditioning control such as battery cooling or heating.

When the determination result in step S150 indicates that the battery conditioning is necessary, the battery temperature change forecasting unit 120 activates the battery conditioning function and controls the battery conditioning unit 130 to perform temperature control such as battery cooling or heating (step S160). The battery temperature change forecasting unit 120 operates a battery heating device when the battery heating is required to reach the optimal temperature, and operates a battery cooling device when the battery cooling is required. When the determination result in step S150 indicates that no battery conditioning is necessary, the battery temperature change forecasting unit 120 deactivates the battery conditioning function and controls the battery conditioning unit 130 to stop the heating or cooling operation (step S170).

Such an operation is performed until the vehicle arrives at the charging station. That is, the battery temperature change forecasting unit 120 confirms whether the vehicle has arrived at the charging station (step S180). When the vehicle has not arrived at the charging station, the battery temperature change forecasting unit 120 repeats the operations of step S140 and the subsequent steps, and when the vehicle has arrived at the charging station, the battery temperature change forecasting unit 120 ends the battery conditioning optimization operation.

In an embodiment, the battery temperature change forecasting unit 120 may forecast the battery temperature changes in real time according to specific time points during driving such as rapid acceleration sections, rapid deceleration sections, stopping sections, or steep slope sections, and events such as reaching a specific section of a driving distance, and changes in external temperature, and determine the intervention time point of a control algorithm. In addition, the battery temperature change forecasting unit 120 may adjust a data collection and processing cycle according to a specific time point during driving or an event that occurs. For example, when rapid changes in the battery temperature are expected during driving, the battery temperature change forecasting unit 120 may perform more frequent and accurate forecasting by shortening the data collection and processing cycle. On the other hand, in constant-speed driving sections with little changes in speed during driving, the battery temperature change forecasting unit 120 may be configured to extend the data collection and processing cycle and reduce power consumption.

An example of a battery temperature forecasting algorithm that reflects driving conditions is described below.

The battery temperature change forecasting unit 120 uses an artificial intelligence model to forecast battery temperature changes during the execution of the battery conditioning function such as battery cooling or battery heating. The battery temperature change forecasting unit 120 calculates the time required to reach optimal temperature by using the forecasted temperature change data. The battery temperature change forecasting unit 120 compares remaining driving time with the time required to reach the optimal temperature to determine whether to perform the battery conditioning.

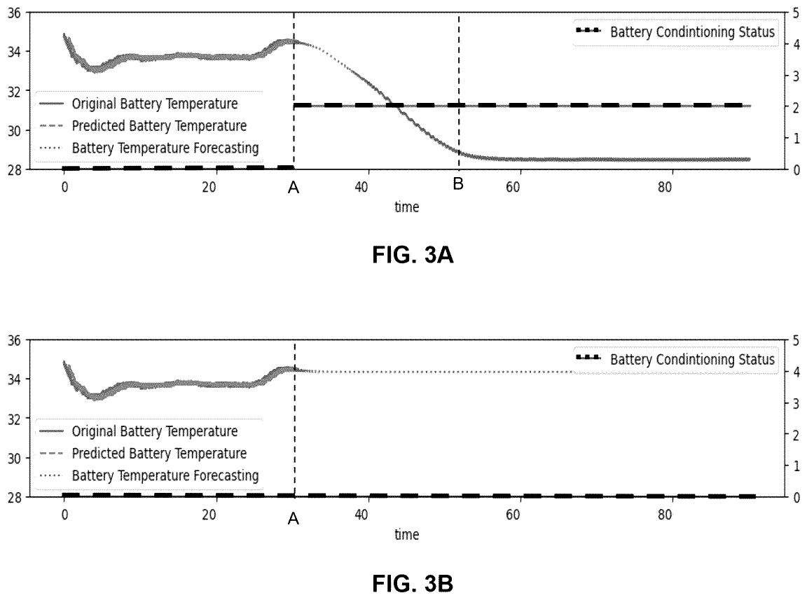

FIG. 3A exemplifies the time required to reach the optimum temperature when the battery conditioning function is performed, and FIG. 3B illustrates predicted changes in battery temperature over time when the battery conditioning function is not performed. In FIG. 3, “A” indicates the current time point. The orange line indicates predicted battery temperature, the blue line indicates measured battery temperature, and the green line indicates time-dependent changes in the predicted battery temperature after the current time point. In FIG. 3, the purple line indicates whether the battery conditioning has been applied. In FIG. 3A where the battery conditioning has been applied, it can be seen that the optimal temperature is reached at the time point indicated by B. This is approximately 22 minutes after the current time point (A). On the other hand, in FIG. 3B where no battery conditioning has been applied, the predicted battery temperature remains at the current temperature of 34° C. even after time has elapsed.

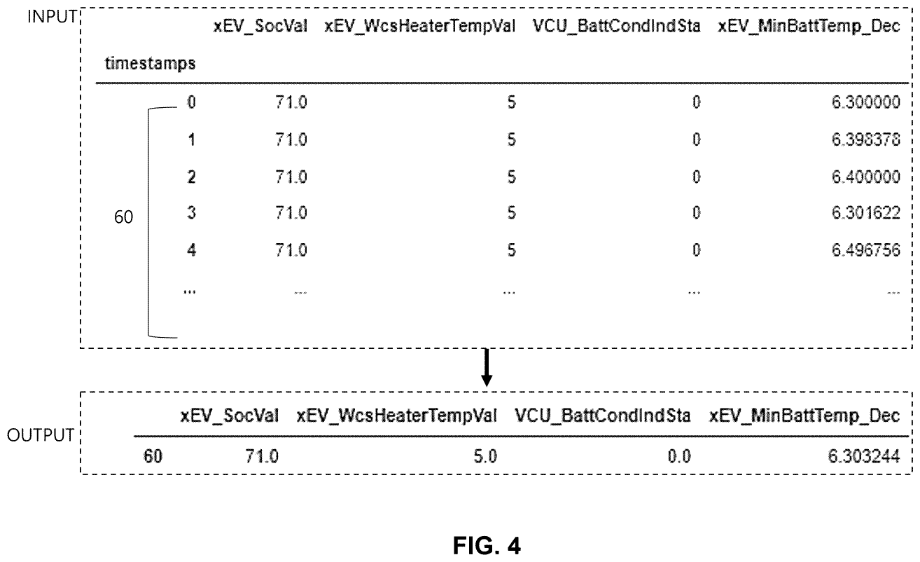

In an embodiment, the battery temperature change forecasting unit 120 may forecast temperature after a predetermined time by using data during predetermined timestamps, and then repeat this process for the next time zone, thereby forecasting battery temperature over time. For example, as illustrated in FIG. 4, the battery temperature change forecasting unit 120 forecasts temperature after one second by using data during immediately previous 60 timestamps at the current time point. Subsequently, the battery temperature change forecasting unit 120 may forecast the battery temperature over time by repeating a process of using data during immediately previous 60 timestamps in the next time zone, that is, one second later and forecasting temperature after the one second.

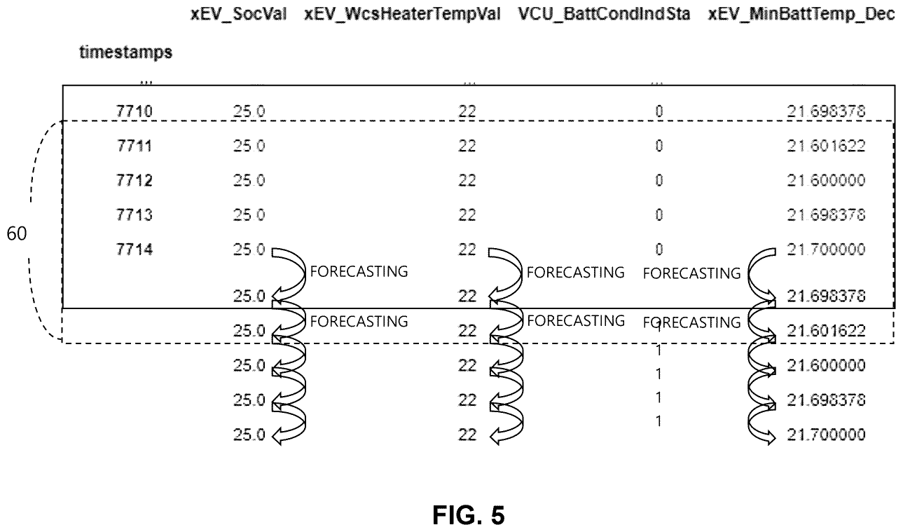

For example, when the current time point is t, the battery temperature change forecasting unit 120 uses data during 60 timestamps immediately before the current time point to forecast temperature one second later (t+1), as indicated by the solid box in FIG. 5. Subsequently, the battery temperature change forecasting unit 120 uses data during previous 60 timestamps at the time point (t+1) after one second to forecast temperature after two seconds (t+2). In such a case, the data during the 60 timestamps including the data forecasted at the time point t are used as indicated by the dotted box in FIG. 5. In this way, the battery temperature change forecasting unit 120 repeats a process of forecasting temperature after T+1 seconds (t+T+1) by using data during immediately previous 60 timestamps at the time point (t+T) after T seconds until the time required to reach a final destination is reached, as illustrated in FIG. 5, thereby forecasting temperature changes occurring until arrival at to the final destination.

On the other hand, the number of immediately previous timestamps for forecasting and/or time between timestamps (hereinafter, referred to as “time window”) may be appropriately adjusted in real time according to driving conditions. For example, when rapid changes in battery temperature are expected during driving, the data collection and processing cycle may be shortened to perform more frequent and accurate forecasting. When battery temperature changes are stable, system load may be reduced through forecasting with a relatively long cycle. The battery temperature change forecasting unit 120 may change the data collection cycle and the driving condition determination cycle for driving condition determination in the driving condition determination unit 110 and the algorithm execution cycle in the battery temperature change forecasting unit 120, according to time window values set in real time.

In an embodiment, the battery temperature change forecasting unit 120 determines the intervention time point of the control algorithm in consideration of driving efficiency and charging efficiency. For example, the battery temperature change forecasting unit 120 forecasts battery temperature changes in real time according to specific time points during driving such as rapid acceleration sections, rapid deceleration sections, stopping sections, or steep slope sections, and events such as reaching a specific section of a driving distance, and changes in external temperature, and determines the intervention time point of the control algorithm, thereby achieving energy consumption optimization and efficiency maximization.

In an embodiment, in addition to initiating the battery conditioning operation of the present disclosure when a driver inputs a charging station to a navigation system as a destination and starts driving, some embodiments may also be configured to manually initiate the battery conditioning operation of the present disclosure when desired by a user. Furthermore, the cooling or heating time required to reach an optimal battery state may also be calculated by a user request.

Although preferred embodiments of the present disclosure have been described above, those skilled in the art will understand that various modifications and changes can be made to the present disclosure without departing from the spirit and scope of the present disclosure as set forth in the claims below.

What is claimed is:

1. A battery conditioning optimization apparatus for a vehicle comprising:
a controller and a memory, the controller comprising:
a driving condition determination unit configured to: collect in real time driving data that affects driving conditions of the vehicle, analyze the collected driving data, and determine the driving conditions;
a battery temperature change forecasting unit configured to: monitor a current temperature and a state of a battery, and forecast battery temperature changes based on the current temperature and the state of the battery and information on the driving conditions provided by the driving condition determination unit; and
a battery conditioning unit including a cooling device for lowering a temperature of the battery and a heating device for raising the temperature of the battery, and configured to cool the battery or raise the temperature of the battery under the control of the battery temperature change forecasting unit,
wherein the battery temperature change forecasting unit controls the battery conditioning unit to control the temperature of the battery based on the forecasted battery temperature changes.

2. The battery conditioning optimization apparatus of claim 1, wherein the battery temperature change forecasting unit includes a plurality of battery temperature forecasting models, and
the driving condition determination unit determines current driving conditions and selects a battery temperature forecasting model suitable for the current driving conditions from the plurality of battery temperature forecasting models.

3. The battery conditioning optimization apparatus of claim 1, wherein the battery temperature change forecasting unit forecasts the battery temperature changes to calculate time required to reach optimal temperature, compares the calculated time required to reach the optimal temperature with remaining driving time until arrival at a charging station, and determines whether to activate battery conditioning control.

4. The battery conditioning optimization apparatus of claim 3, wherein the battery temperature change forecasting unit includes map data that records a relationship among cooling or heating time required to reach an optimal battery state, current battery temperature, and ambient temperature, and calculates the cooling or heating time required to reach the optimal battery state by using the map data.

5. The battery conditioning optimization apparatus of claim 3, wherein, when a difference between the remaining driving time and the cooling or heating time required to reach the optimal state is within a predetermined error range, the battery temperature change forecasting unit controls the battery conditioning unit to perform a battery conditioning operation.

6. The battery conditioning optimization apparatus of claim 1, wherein the battery temperature change forecasting unit adjusts a data collection and processing cycle according to a driving section during driving or an event that occurs.

7. The battery conditioning optimization apparatus of claim 6, wherein the battery temperature change forecasting unit forecasts battery temperature over time by repeating a process of forecasting of temperature after a predetermined time by using data during immediately previous predetermined timestamps at a current time point, and forecasting of temperature after a predetermined time by using data during immediately previous predetermined timestamps with respect to a time point after the predetermined time.

8. The battery conditioning optimization apparatus of claim 1, wherein a driving condition determination algorithm of the driving condition determination unit is implemented using an artificial intelligence model trained using various driving data.

9. The battery conditioning optimization apparatus of claim 1, wherein the battery conditioning optimization apparatus performs a battery conditioning operation when a charging station is set in a navigation system as a destination.

10. The battery conditioning optimization apparatus of claim 1, wherein the driving data that affects the vehicle driving conditions include driver's driving characteristics, road conditions, and environmental factors.

11. A battery conditioning optimization method for a vehicle, the method comprising:
collecting, by a controller, in real time driving data that affects driving conditions of the vehicle, analyzing the collected driving data, and determining the driving conditions;
monitoring, by the controller, a current temperature and a state of a battery, forecasting battery temperature changes based on the current temperature and the state of the battery and information on the driving conditions, and determining whether to control the temperature of the battery based on the predicted battery temperature changes; and
cooling the battery or raising the temperature of the battery, by the controller, according to the determination.

12. The battery conditioning optimization method of claim 11, wherein forecasting the battery temperature changes is performed by one of a plurality of battery temperature forecasting models, and further comprising:
determining current driving conditions and selecting, as the one battery temperature forecasting model to be performed, a battery temperature forecasting model most suitable for the current driving conditions from the plurality of battery temperature forecasting models.

13. The battery conditioning optimization method of claim 11, further comprising:
forecasting the battery temperature changes to calculate time required to reach optimal temperature, and
comparing the calculated time required to reach the optimal temperature with remaining driving time until arrival at a charging station, and determining whether to activate battery conditioning control.

14. The battery conditioning optimization method of claim 13, wherein a cooling or heating time required to reach an optimal battery state is calculated using map data that records a relationship among the cooling or heating time, current battery temperature, and ambient temperature.

15. The battery conditioning optimization method of claim 13, further comprising:
performing a battery conditioning operation when a difference between the remaining driving time and the cooling or heating time required to reach the optimal state is within a predetermined error range.

16. The battery conditioning optimization method of claim 11, further comprising:
adjusting a data collection and processing cycle according to a driving section during driving or an event that occurs, wherein the battery temperature over time is forecasted by repeating a process of forecasting of temperature after a predetermined time by using data during immediately previous predetermined timestamps at a current time point, and forecasting of temperature after a predetermined time by using data during immediately previous predetermined timestamps with respect to a time point after the predetermined time.

17. The battery conditioning optimization method of claim 11, wherein collecting the driving data is carried out using an artificial intelligence model trained using various driving data.

18. The battery conditioning optimization method of claim 11, wherein cooling the battery or raising the temperature of the battery is performed when a charging station is set in a navigation system as a destination.

19. The battery conditioning optimization method of claim 11, wherein the driving data includes driver's driving characteristics, road conditions, and environmental factors.

20. A non-transitory computer readable medium containing program instructions executed by a processor, the computer readable medium comprising:
program instructions that collect in real time driving data that affects driving conditions of a vehicle, analyze the collected driving data, and determine the driving conditions;
program instructions that monitor a current temperature and a state of a battery, forecast battery temperature changes based on the current temperature and the state of the battery and information on the driving conditions, and determine whether to control the temperature of the battery based on the predicted battery temperature changes; and
program instructions that cool the battery or raise the temperature of the battery, according to the determination.
